(19) United States
(12) Patent Application Publication
(10) Pub. No.: US 2025/0167379 A1
(43) Pub. Date: May 22, 2025

(54) VALVE FOR A BATTERY PACK AND A BATTERY PACK

(71) Applicant: Ford Global Technologies, LLC, Dearborn, MI (US)

(72) Inventors: Fei Gao, Nanjing (CN); Robin Zhou, Nanjing (CN); Larry Wang, Nanjing (CN)

(21) Appl. No.: 18/936,022

(22) Filed: Nov. 4, 2024

(30) Foreign Application Priority Data
Nov. 17, 2023 (CN) 2023115387834

(51) Int. Cl. H01M 50/333; H01M 50/249; H01M 50/30; H01M 50/342

(52) U.S. Cl. CPC H01M 50/333; H01M 50/249; H01M 50/3425; H01M 50/394; H01M 2200/20

(57) ABSTRACT

The present disclosure relates to the field of vehicles, and specifically provides a valve for a battery pack. The valve comprises: a valve bracket having a first opening located at one end and a second opening located at the other end; a breathable membrane that covers the first opening; and a piston that covers the second opening and includes a hole closed by an openable sealing portion. The present disclosure also discloses a battery pack using the above-mentioned valve. By using the above-mentioned valve, the pressure inside and outside the battery pack can be balanced, effective waterproof and dustproof can be achieved, and the pressure inside the battery pack can be more effectively controlled when it rises rapidly.

### CROSS-REFERENCE TO RELATED APPLICATIONS

This disclosure claims priority to Chinese Patent Application No. 2023115387834, which was filed on 17 Nov. 2023 and is incorporated herein by reference in its entirety.

### TECHNICAL FIELD

The present disclosure generally relates to the technical field of vehicles, and more specifically, to a valve for a vehicle battery pack and a battery pack using the valve.

### BACKGROUND

Normally, valves are used for pressure exchange between enclosed containers and outside to achieve a desired pressure balance. In practical applications, the valves have a variety of valve structures and rich application scenarios. In the field of vehicles, electrified vehicles have developed rapidly. The electrified vehicles include, but are not limited to, hybrid vehicles, plug-in hybrid vehicles, and pure electric vehicles. The typical electrified vehicles usually include battery packs, and the valves with pressure balancing effects are also commonly used in the battery packs. As the range of pure electric vehicles increases, ternary batteries are used in battery pack design. The airtightness of the battery becomes more important for the normal operation of the electric vehicles. Good airtightness can effectively prevent water, water vapor, or dust from entering the battery packs and affecting the internal environment of the battery packs. However, it is necessary to meet the requirements of balancing the air pressure inside and outside the battery packs and quickly exhausting if necessary.

### SUMMARY

According to the present disclosure, there is provided a valve for a battery pack, comprising: a valve bracket having a first opening located at one end and a second opening located at the other end; a breathable membrane that covers the first opening; and a piston that covers the second opening and includes a hole closed by an openable sealing portion.

According to an embodiment of the present disclosure, the sealing portion is at least one of a sealing core, a valve disc, and a notch.

According to an embodiment of the present disclosure, the sealing core is biased in a first direction by a first elastic member to close the hole.

According to an embodiment of the present disclosure, the piston is biased in a second direction by a second elastic member to cover the second opening.

According to an embodiment of the present disclosure, the valve bracket further comprises a base that supports the first elastic member, on which the second opening is provided.

According to an embodiment of the present disclosure, the piston has a supporting portion at its bottom, by which the first elastic member is supported.

According to an embodiment of the present disclosure, the valve bracket has a guide groove, and the sealing core is biased by the first elastic member to partially pass through the hole and enter the guide groove.

According to an embodiment of the present disclosure, the sealing core moves in the second direction under a first pressure difference to open the hole, so as to allow gas from external environment to flow into an interior of a shell of the battery pack.

According to an embodiment of the present disclosure, the notch deforms under a first pressure difference to open the hole, so as to allow gas from external environment to flow into an interior of a shell of the battery pack.

According to an embodiment of the present disclosure, the valve disc pivots around a disc shaft under a first pressure difference to open the hole.

According to an embodiment of the present disclosure, the piston moves in the first direction under a second pressure difference to open the first opening, so as to allow gas inside a shell of the battery pack to flow out.

According to an embodiment of the present disclosure, the sealing core is a sealing plate that covers the hole to close the hole.

According to an embodiment of the present disclosure, the sealing core has a core body and a flange extending outward from the core body in a circumferential direction and biased by the first elastic member to abut against the hole to seal the hole.

According to an embodiment of the present disclosure, the sealing core has a first spike extending towards the breathable membrane and spaced apart from the breathable membrane by a first gap.

According to an embodiment of the present disclosure, the valve further comprises a valve cover having a connecting portion connected to a shell of the battery pack; the valve cover is attached to an upper end of the valve bracket and covers the breathable membrane with a second gap; and the valve cover has a second spike extending towards the breathable membrane and having a length smaller than the second gap.

According to an embodiment of the present disclosure, the valve cover has at least one valve cover window located on a side wall and above the breathable membrane in a longitudinal direction when the valve cover is attached to the upper end of the valve bracket.

According to an embodiment of the present disclosure, the base and a body of the valve bracket are connected together in a detachable manner or integrally formed.

According to the present disclosure, there is provided a method for controlling the pressure of a battery pack, comprising: providing at least one gas exchange chamber with a first channel and a second channel, wherein the first channel and the second channel are respectively in fluid communication with external environment and interior of a shell of the battery pack; wherein the gas exchange chamber is configured to: close the first channel and the second channel when there is no pressure difference; open the first channel when there is a first pressure difference to allow gas from the external environment to flow into the interior of the shell of the battery pack; and open the second channel when there is a second pressure difference to allow gas inside the shell of the battery pack to flow to the external environment.

According to an embodiment of the present disclosure, the method further comprises: providing a breathable membrane between the gas exchange chamber and the external environment to prevent moisture from entering the gas exchange chamber; and rupturing the breathable membrane to increase gas passage through the second channel when the second pressure difference is greater than a threshold.

According to yet another aspect of the present disclosure, there is provided a battery pack comprising a valve installed on a shell of the battery pack, wherein the valve comprises: a valve bracket having a first opening located at one end and a second opening located at the other end; a breathable membrane that covers the first opening; and a piston that covers the second opening and includes a hole closed by an openable sealing portion.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like referenced numerals refer to like parts throughout the different figures.

FIG. 1 shows an electrified vehicle to which a battery pack according to the present disclosure can be applied;

FIGS. 2A to 2B show front and top views of a valve that can be used for the vehicle battery pack according to an embodiment of the present disclosure;

FIG. 3 shows an internal structural diagram of the valve that can be used for the vehicle battery pack according to an embodiment of the present disclosure;

FIGS. 3A to 3C show schematic diagrams of gas flow direction of the valve in the embodiment of FIG. 3 of the present disclosure in different working states;

FIGS. 4A to 4B show exploded structural schematics of the valve that can be used for the vehicle battery pack according to an embodiment of the present disclosure;

FIG. 5 shows a schematic diagram of a valve bracket of the valve according to an embodiment of the present disclosure;

FIG. 6A shows a schematic diagram of the cooperation between a piston and a base according to an embodiment of the present disclosure;

FIG. 6B shows a schematic diagram of the cooperation between a compression core of the piston and the base according to an embodiment of the present disclosure;

FIGS. 7A to 7B show a structural schematic of a piston body of the piston according to an embodiment of the present disclosure;

FIG. 8 shows a structural schematic of the cooperation between the base and a bracket cap according to an embodiment of the present disclosure; and

FIGS. 9A to 9C show cross-sectional views of the valve in different working states taken along the line X-X of FIG. 2B according to an embodiment of the present disclosure.

### DETAILED DESCRIPTION

Embodiments of the present disclosure will now be described in detail with reference to the accompanying drawings. For reference numbers in the drawings, the same or similar reference numbers are used to designate the same or similar parts. In the following description, various operating parameters and components are described in various embodiments. These specific parameters and components are included herein by way of example only and are not meant to be limiting.

The embodiments of the present disclosure are described below. However, it is to be understood that the disclosed embodiments are merely examples and that other embodiments may take various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of the features shown provide representative embodiments for typical applications. However, various combinations and modifications of the features consistent with the teachings of the present disclosure may be desirable for certain particular applications or implementations

In the present application, relational terms, such as first and second and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “and/or” when used in a list of two or more items, means that any one of the listed items can be employed by itself, or any combination of two or more of the listed items can be employed.

One or more embodiments of the present disclosure will be described below with reference to the accompanying drawings. The flowchart is used to illustrate an example of a process executed by a system. It should be understood that the execution of the flowchart does not need to be performed in sequence, and one or more steps may be omitted, or one or more executed steps may be added, and one or more steps may be performed sequentially or in reverse order, and even in some embodiments concurrently.

As mentioned in the background, the valves can be used for pressure exchange between the enclosed containers and the outside to achieve the desired pressure balance. With the rapid development of the electrified vehicles due to their advantages in reducing fuel consumption and exhaust emissions, the valves are widely used in the battery packs in order to achieve waterproof and dustproof sealing of the battery packs, as well as gas exchange under different pressures to balance the pressure inside and outside the battery packs.

Exemplary embodiments or the present disclosure include a valve that has one or more advantages in structural robustness, ease of connection, and ease of testing. In one or more embodiments, the present application also provides a battery pack using the above-mentioned valve, which can maintain pressure balance under normal pressure conditions and effectively prevent water vapor and other substances from entering the interior of the battery pack, open an air circulation channel to balance the pressure between the interior of the battery pack and the external environment when there is a pressure difference between the interior of the battery pack and the external environment, and can furthermore effectively reduce the pressure inside the battery pack during a thermal event. In one example of the present disclosure, when the pressure difference between the external environment and the interior of the battery pack is 3-4Kpa, the valve provides an air flow rate of not less than 25 ml/min for the air circulation channel facing the interior of the battery pack; when the pressure difference between the interior of the battery pack and the external environment is 1-1.8Kpa, the valve provides an air flow rate of not less than 1 L/min for the air circulation channel towards the external environment; and when the pressure difference between the interior of the battery pack and the external environment is 8-12Kpa, the valve provides an air flow rate of not less than about 1000 L/min for the air circulation channel towards the external environment.

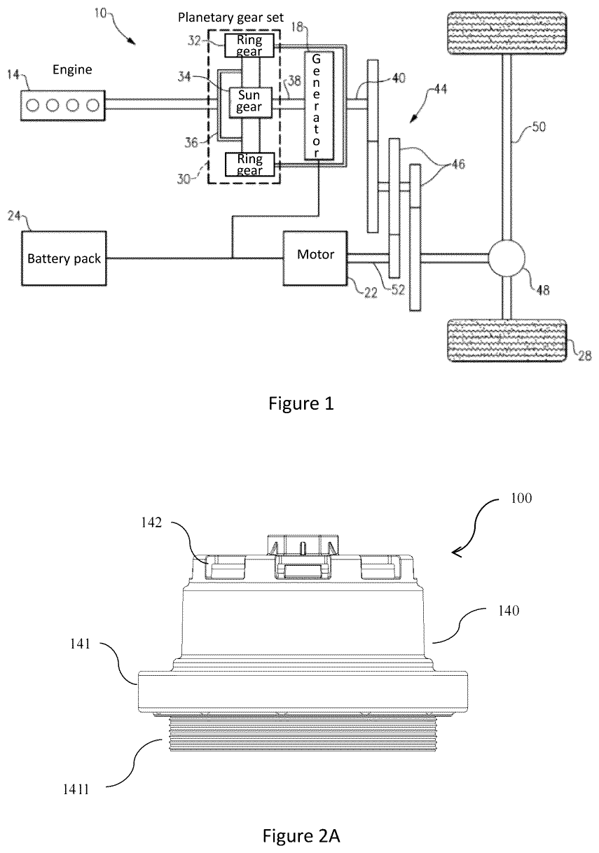

Referring to FIG. 1, one example of an electrified vehicle 12 to which a battery pack according to the present disclosure can be applied is shown. Although depicted as a hybrid electric vehicle (HEV), it should be understood that the battery pack according to the present disclosure may be applied to other types of electrified vehicle, such as plug-in deep hybrid electric vehicles (PHEVs), pure electric vehicles (BEVs), full hybrid electric vehicles (FHEVs), etc.

In one embodiment, a powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery assembly. In this example, the second drive system is considered an electric drive system of the powertrain 10. The first and second drive systems generate torque to drive one or more sets of vehicle drive wheels 28 of the electrified vehicle 12. Although a power-split configuration is shown in this illustrative embodiment, this disclosure extends to any hybrid electric vehicle including full hybrids, parallel hybrids, series hybrids, mild hybrids or micro hybrids. The engine 14 and the generator 18 may be connected through a power transfer unit 30. In addition to planetary gear set, other types of power transfer units may be used to connect the engine 14 to the generator 18. In a non-limiting embodiment, the planetary gear set includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The battery assembly 24 is an example type of battery assembly for the electrified vehicle. The battery assembly 24 may provide power to drive a motor, and in a regenerative mode, the motor 22 and the generator 18 may output power to the battery assembly 24 for storage. The battery assembly 24 may include a high voltage battery pack, which may include a plurality of battery arrays. In the following embodiments, the battery pack that can be incorporated into the above-described example electrified vehicles are provided.

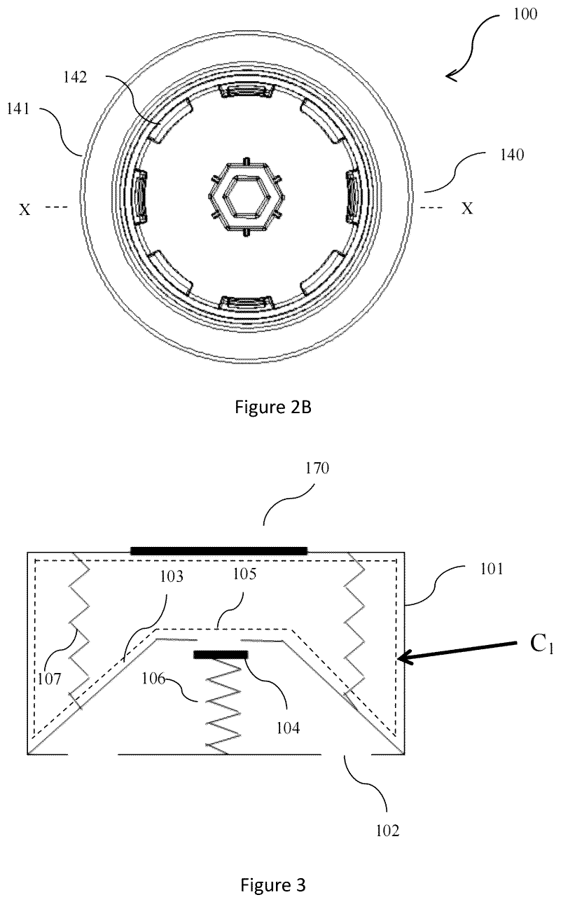

FIGS. 2A to 2B show front and top views of a valve 100 according to one and more embodiments of the present disclosure. As shown in the figure, the valve 100 has a valve cover 140. The valve cover 140 has a main body portion and a lower end edge 141 protruding from the main body portion and extending circumferentially. The valve cover 140 also has a threaded portion 1411 at its lower end. In the embodiment of the present disclosure, the valve cover 140 can be connected to a shell of the battery pack through the threaded portion 1411 to complete the connection between the valve 100 and the battery pack. It can be understood that other connection methods such as welding, fastener connection, adhesive bonding, etc. can also be used for the connection between the valve 100 and the shell of the battery pack. The structure of the valve 100 will be explained below with reference to further figures.

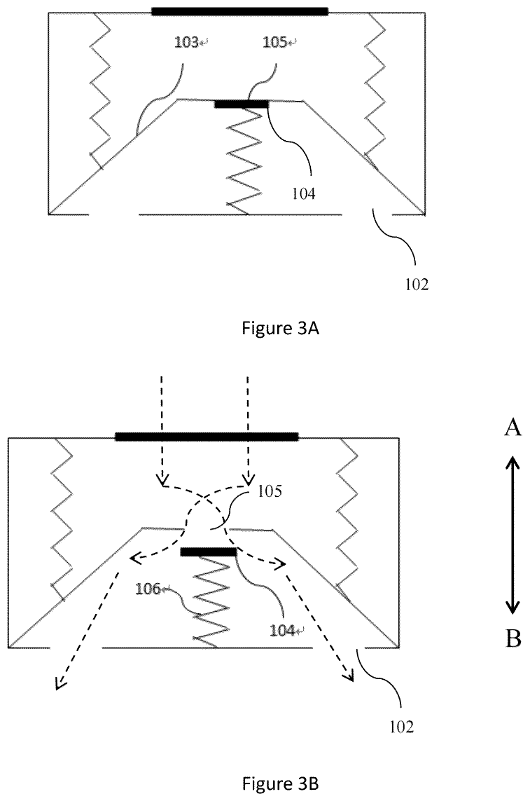

FIG. 3 shows an internal structural diagram of the valve 100 for the battery pack according to an embodiment of the present application. The valve 100 includes a valve bracket 101. The valve bracket 101 has a first opening covered by a breathable membrane 170 and connected to the external environment. The valve bracket 101 also has second openings 102. In this embodiment, the number of the second openings 102 is two; however, those skilled in the art can understand that the number of the second openings 102 can be set according to the requirements of ventilation volume and structural strength of the valve bracket 101. In the embodiment shown in FIG. 3, the second openings 102 are covered by a piston 103, which is supported on the valve bracket 101 by a second elastic member 107 so as to be biased to cover and seal the second openings 102. The piston 103 has a hole 105 closed by a sealing portion at its upper end. In FIG. 3, the hole 105 is clearly shown by separating the sealing portion from the hole 105. In the embodiment shown in FIG. 3, the sealing portion is embodied as a sealing core 104, which, in this example, is a sealing plate that is biased by a first elastic member 106 to close the hole 105. It can be understood that in other embodiments of the present disclosure, the sealing portion can achieve the closure of the hole 105 through a valve disc or notch. For example, the valve disc closes or opens the hole 105 by pivoting around an shaft, on which a spring is provided to bias the valve disc against the hole 105. In another embodiment, the sealing portion may not be biased by the elastic member, instead, the hole 105 can be formed by a deformable material, for example, a notch with a shape that can be set according to the required pressure threshold (can be set in various shapes such as a straight, cross, semi-circular, etc.) is provided on an upper surface of the piston 103 formed by the deformable material, the notch closes the hole 105 under normal conditions, and opens the hole 105 through the deformation of the notch material when subjected to a pressure greater than a threshold. In addition, in the embodiment shown in FIG. 3, the first elastic member 106 is supported on a supporting portion of a bracket bottom wall where the second openings 102 of the valve bracket 101 are located. In the embodiment of the present disclosure, the supporting portion is integrally formed with the valve bracket 101 or fixed to the valve bracket 101 by mechanical connection, adhesive bonding, or other means.

Continuing with reference to FIG. 3, a gas exchange chamber C1 formed by the valve bracket 101, the breathable membrane 170, the piston 103, and the sealing core 104 in the internal structure of the valve 100 is illustrated with dashed lines. This gas exchange chamber C1 serves as a gas buffer area between the external environment and the interior of the battery pack, and has a first channel and a second channel for gas exchange, especially for gas exchange under different external environmental pressures and internal pressure states of the battery pack.

Specifically, FIGS. 3A-3C show schematic diagrams of gas flow direction of the valve 100 in the embodiment of FIG. 3 in different working states. Firstly, as shown in FIG. 3A, when a pressure difference between the gas pressure of the external environment and the air pressure inside the battery pack is within a threshold range, the hole 105 and the second opening 102 are respectively closed by the sealing core 104 and the piston 103, thereby closing the first channel and the second channel, resulting in the inability of gas exchange between the external environment and the interior of the battery pack.

In the working state shown in FIG. 3B, as indicated by a dashed arrow, when the pressure difference between the gas pressure of the external environment and the gas pressure inside the battery pack exceeds the threshold, the sealing core 104 moves in a second direction B under the pressure difference, the first elastic member 106 is compressed, and the hole 105 is opened, thus the first channel for gas flow from the external environment to the interior of the battery pack is opened, so that the gas from the external environment flow into the interior of the battery pack to achieve pressure balance.

Next, in the working state shown in FIG. 3C, as indicated by a dashed arrow, when the gas pressure inside the battery pack increases and forms a pressure difference exceeding the threshold with the gas pressure of the external environment, the piston 103 moves in a first direction A under the pressure difference, the second elastic member 107 is compressed, and the second openings 102 are no longer covered by the bottom of the piston 103, thus the second channel for gas flow inside the battery pack towards the external environment is opened, so that the gas inside the battery pack is discharged to the external environment to achieve pressure balance.

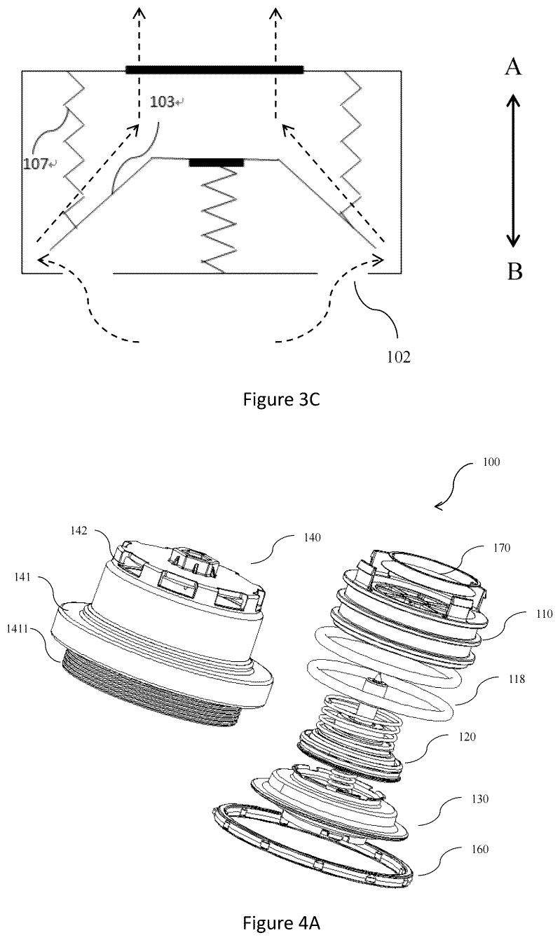

FIGS. 4A to 4B show exploded structural schematics of the valve 100 for the battery pack according to another embodiment of the present application. Those skilled in the art should understand that although the structure of the valve 100 in the present application is used for the vehicle battery pack, it can also be applied to any suitable scenario that requires maintaining pressure balance inside and outside the container.

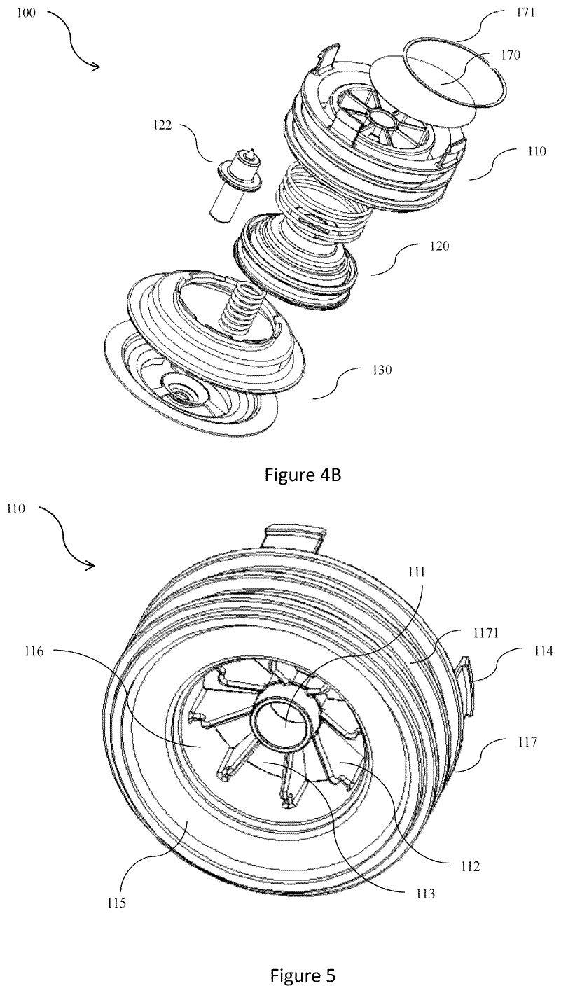

Continuing with reference to FIGS. 4A to 4B and FIG. 5, in one or more embodiments of the present disclosure, there is provided a valve 100, which comprises a valve bracket 110, a piston 120, a base 130, a valve cover 140, and a breathable membrane 170. In the embodiment of the present disclosure, the valve bracket 110 has a guide groove 111 extending in a longitudinal direction, multiple ribs 112 spaced apart from each other and extending from the guide groove 111 towards an inner peripheral wall 116, and multiple first vent holes 113 formed between every two adjacent ribs 112 and capable of fluid communication with the external ambient gas. In addition, in the embodiment of the present disclosure, the valve bracket 110 has an annular supporting portion 115 extending from a lower edge of the inner peripheral wall 116 towards a lower end of the valve bracket 110. In the embodiments of the present disclosure, the supporting portion 115 can be used for the installation and support of the elastic member. An outer peripheral wall 117 of the valve bracket 110 also has grooves 1171 extending in a circumferential direction of the outer peripheral wall 117. In the embodiment of the present disclosure, the grooves 1171 is provided as two parallel grooves, and it can be understood that the number of the grooves 1171 can be provided according to the sealing requirements. Two sealing rings 118 are pressed into the grooves 1171, respectively, to achieve a sealing effect between the valve cover 140 and the valve bracket 110 when the valve bracket 110 is clamped to the valve cover 140 through multiple clamping portions 114 spaced apart on an upper end.

Continuing with reference to FIGS. 4A to 4B and FIG. 5, in the embodiment of the present disclosure, the guide groove 111 and the multiple first vent holes 113 on the valve bracket 110 are covered by the breathable membrane 170 from the upper end of the valve bracket 110. The material of the breathable membrane 170 can be e-PTEF (expanded PTFE, expanded polytetrafluoroethylene), and the breathable membrane 170 can selectively prevent the passage of liquid and only allow gas to pass through. In the embodiment of the present disclosure, the breathable membrane 170 is welded to the upper end of the valve bracket 110 by ultrasonic welding through a welding ring 171. It can be understood that the breathable membrane 170 can also be fixed to the upper end of the valve bracket 110 using other connection methods such as bonding. In the embodiments of the present disclosure, the welding ring 171 may be made of polyethylene and/or fiberglass material.

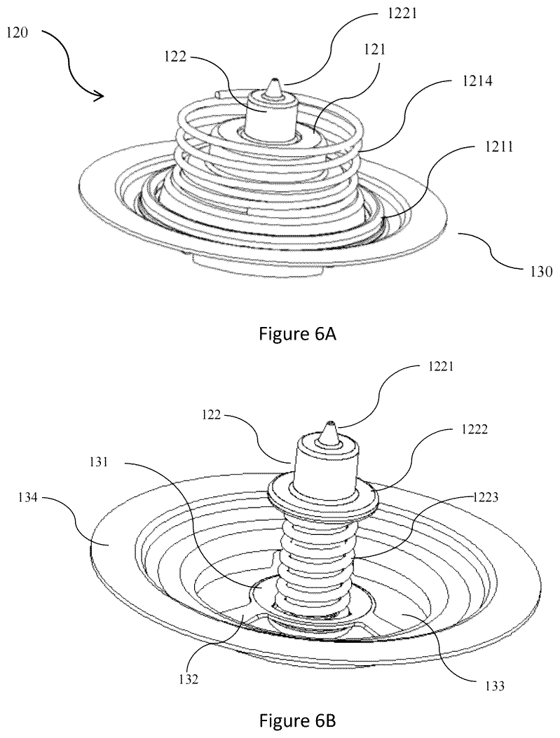

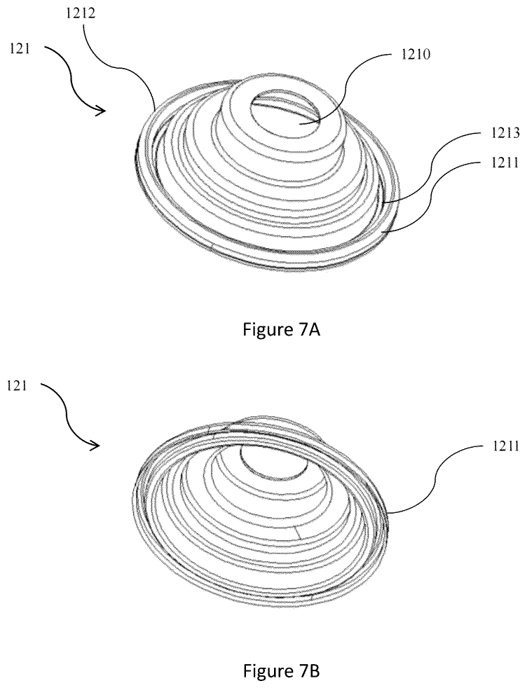

Next, with reference to FIGS. 4A to 4B and in conjunction with FIGS. 6A to 6B, the piston 120 has a piston body 121 and a compression core 122. Referring to FIGS. 6A to 6B, it can be seen that the piston body 121 has a generally conical body portion, with an opening 1210 at its upper end and an edge 1211 extending in the circumferential direction at its lower end. The edge 1211 has a protruding portion 1212 that extends upwards and forms a support groove 1213 with the body portion in the circumferential direction. In the embodiment of the present disclosure, the support groove 1213 can be used to install and support the elastic members. Continuing with reference to FIGS. 6A to 6B, the compression core 122 has a cylindrical body portion and an upper end portion with a first spike 1221. A flange 1222 extending outward in the circumferential direction is provided between the upper end portion and the body portion. When the compression core 122 is installed from the lower end portion of the piston body 121, the upper end portion of the compression core 122 passes through the opening 1210 of the piston body 121 and then rest against the opening 1210 with the flange 1222, thereby achieving the positioning of the piston body 121 and the compression core 122. The piston body 121 cooperates with the valve bracket 110 through an elastic member, which is a second spring 1214 in the embodiment of the present disclosure. The second spring 1214 is supported at one end in the supporting portion 115 of the valve bracket 110, and at the other end in the support groove 1213 of the piston body 121. When the two cooperate through the second spring 1214, the opening 1210 of the piston body 121 aligns with the guide groove 111 of the valve bracket 110. Continuing with reference to FIG. 6B, in the embodiment of the present disclosure, the compression core 122 can be supported by the base 130. More specifically, the base 130 has a central supporting portion 131, and multiple extension arms 132 extending radially from the central supporting portion 131 to inner edges of the annular body. Multiple second vent holes 133 are formed between each two extension arms 132. The second vent holes 133 are in communication with the gas inside the battery pack. The elastic member is either the first spring 1223 or the second spring 1214 in the embodiment of the present disclosure. Wherein the first spring 1223 is fitted onto the main body of the compression core 122, with one end supported by the central supporting portion 131 of the base 130 and the other end resting on the flange 1222 of the compression core 122. The compression core 122 is biased by the first spring 1223 so that its front end passes through the opening 1210 and extends into the guide groove 111 of the valve bracket 110.

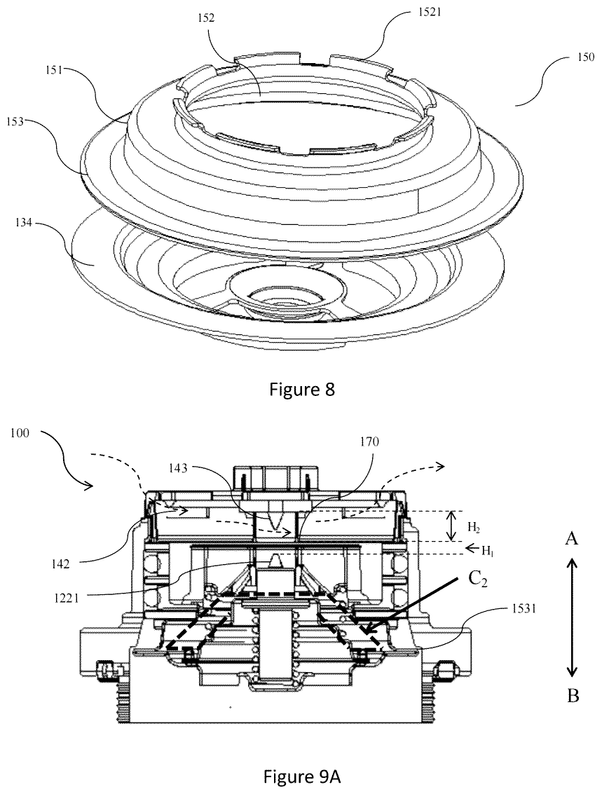

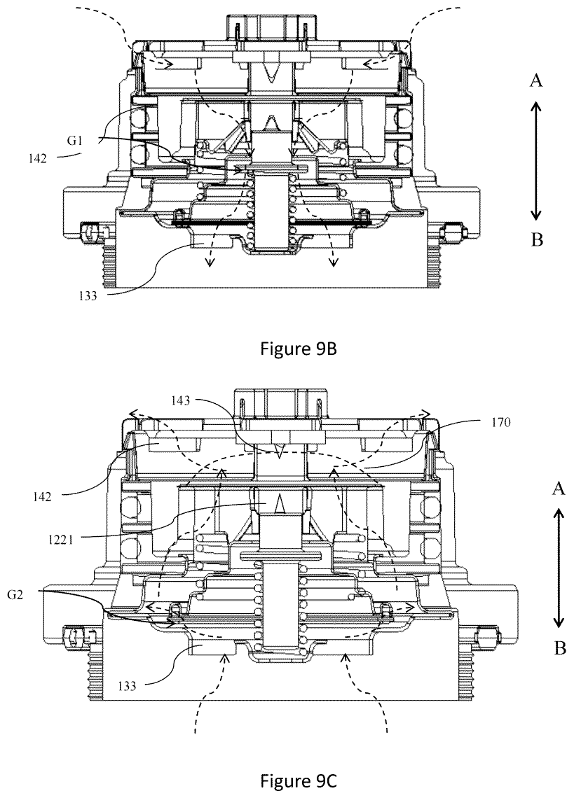

Referring to FIGS. 4A, 4B, and 8, in the embodiment of the present disclosure, the valve 100 further includes a bracket cap 150. The bracket cap 150 has a cap body 151, an upper end opening 152, and a lower flange 153. In the embodiment of the present disclosure, the upper end opening 152 has multiple clamping portions 1521 spaced apart in the circumferential direction. The multiple clamping portions 1521 are formed by curling the edges of the upper end opening 152 upward. The multiple clamping portions 1521 can be clamped into clamping grooves of the valve bracket 110 to achieve engagement with the valve bracket 110. As shown in FIG. 9A, the lower flange 153 of the bracket cap 150 is curled downward and inward to form the clamping grooves 1531 that is adapted to a lower edge 134 of the base 130. The clamping grooves 1531 opens inward and the lower edge 134 of the base 130 can be clamped into the clamping grooves 1531 of the bracket cap 150, so that the base 130 can be connected to the valve bracket 110 through the bracket cap 150.

Referring again to FIGS. 4A and 4B, a sealing gasket 160 can be clamped into a slot 1410 provided on an inner side of the lower end edge 141 of the valve cover 140, so that when the valve cover 140 is connected to the shell of the battery pack through the threaded portion 1411, the sealing effect between the valve cover 140 and the shell of the battery pack can be achieved. Referring to FIG. 9A, in the embodiment of the present disclosure, a second spike 143 is provided on the inner surface of the valve cover 140 facing the breathable membrane 170, and the second spike 143 extends from the inner surface of the valve cover 140 towards the breathable membrane 170. In the embodiment of the present disclosure, a reinforcing rib (not shown in the figure) is provided at the connection between the second spike 143 and the inner surface of the valve cover 140. The reinforcing rib is in a cross shape, and the bottom of the second spike 143 is arranged at the center of the cross shape, thereby giving the second spike 143 higher structural strength. In yet another embodiment of the present disclosure, the valve cover 140, the reinforcing rib, and the second spike 143 may be integrally formed by molding. When the valve cover 140 is attached to the valve bracket 110, the second spike 143 has a length smaller than second gap H2 between the inner surface of the valve cover 140 and the breathable membrane 170.

Next, with reference to the cross-sectional view of the valve 100 shown in FIGS. 9A to 9C, the different working states of the valve 100 under different pressure differentials caused by the internal pressure of the battery pack and the external environmental pressure when used on the shell of the battery pack is shown.

Firstly, referring to FIG. 9A, in the cross-sectional view of the valve 100 shown in FIG. 9A, the valve 100 is generally in a pressure equilibrium state. In the embodiments of the present disclosure, the pressure equilibrium state indicates that the pressure inside the battery pack is equal to the pressure of the external environment or the pressure difference between the two is within a threshold range, so that the piston 120 will not displace under this pressure difference to open the gas channel and result in gas exchange between the interior and the external environments of the battery pack.

In the equilibrium state shown in FIG. 9A, the compression core 122 is biased by the second spring 1214 so that its front end extends into the guide groove 111, and the flange 1222 of the compression core 122 is biased against the opening 1210 of the piston body 121 to limit the length of the compression core 122 extending into the guide groove 111 and close the opening 1210. In the closed state, the gas from the external environment cannot enter the interior of the battery pack through the valve 100. In the embodiment of the present disclosure, the piston body 121 is biased by the first spring 1223 to abut against the upper surface of the lower edge 134 of the base 130, thereby preventing the gas inside the battery pack from being discharged to the external environment through the valve 100. Therefore, the valve bracket 110, the piston 120, the base 130, and the bracket cap 150 together form the gas exchange chamber C2 inside the valve 100 for controlling the gas exchange between the internal and the external environment of the battery pack. In FIG. 9A, the area of the gas exchange chamber C2 is roughly defined by a thick dashed line. However, it should be understood that due to the complexity of the internal structure of the valve 100 shown in the cross-sectional view of FIG. 9A, the area of the gas exchange chamber C2 defined by the thick dashed line is only exemplary and not a limitation of the present disclosure. In the state shown in FIG. 9A, the gas exchange chamber C2 can isolate the gas and moisture of the external environment from the interior of the battery pack, effectively preventing moisture or water vapor from entering the interior of the battery pack.

Next, with reference to FIG. 9A, as shown in the figure, in the embodiment of the present disclosure, in the state where the valve 100 is installed, a window 142 on the side wall of the valve cover 140 is located above the breathable membrane 170 in the longitudinal direction, so that the moisture entering the interior of the valve cover through the window 142 can be easily discharged to the outside of the valve cover as indicated by a dashed arrow, without affecting the breathable membrane 170 or entering the gas exchange chamber C2 of the valve 100 through the breathable membrane 170.

Next, with reference to FIG. 9B, as shown in the figure, the working state of the valve 100 when the gas pressure of the external environment is greater than the gas pressure inside the battery pack is shown. In the embodiment of the present disclosure, the gas pressure of the external environment being greater than the gas pressure inside the battery pack refers to the first pressure difference between the gas pressure of the external environment and the gas pressure inside the battery pack being greater than a first threshold at which the piston 120 opens. Specifically, when the first pressure difference is greater than the first threshold, the compression core 122 moves in the second direction B under the action of the gas pressure in the external environment, causing the flange 1222 of the compression core 122 to disengage from the opening 1210 of the piston body 121, thereby allowing the gas from the external environment to enter the interior of the battery pack through the first gas channel as indicated by the dashed arrow. Specifically, the gas from the external environment enters the gas exchange chamber C2 through the first vent hole 113 of the valve bracket 110 covered by the breathable membrane 170 from the window 142 of the valve cover 140, and then enters through the gap between the compression core 122 and the opening 1210, and then enters the interior of the battery pack through the second vent hole 133 on the base 130 to achieve pressure balance between the external environment and the interior of the battery pack.

Subsequently, referring to FIG. 9C, as shown in the figure, the working state of the valve 100 when the gas pressure inside the battery pack is greater than the gas pressure of the external environment is shown. In the embodiment of the present disclosure, the gas pressure inside the battery pack being greater than the gas pressure of the external environment refers to the second pressure difference between the gas pressure inside the battery pack and the gas pressure of the external environment being greater than a second threshold at which the piston 120 opens. Specifically, when the second pressure difference is greater than the second threshold, the piston body 121 moves in the first direction A under the action of the gas pressure inside the battery pack, causing the edge 1211 of the piston body 121 to disengage from the upper surface of the lower edge 134 of the base 130, thereby allowing the gas inside the battery pack to be discharged from the second gas channel to the external environment as indicated by the dashed arrow. Specifically, the gas inside the battery pack flows into the gas exchange chamber C from the gap between the edge 1211 of the piston body 121 and the lower edge 134 of the base 130 through the second vent hole 133 on the base 130, and then enters the valve cover 140 through the first vent hole 113 of the valve bracket 110 and the breathable membrane 170, and then is discharged from the window 142 of the valve cover 140 to the external environment, thereby maintaining the air pressure balance between the interior of the battery pack and the external environment.

Continuing with reference to FIG. 9C, when the temperature inside the battery pack rapidly increases (such as fast charging, high output power, etc.), the internal pressure may rise rapidly; when a third pressure difference with the external environment caused by the rapid increase in internal pressure exceeds a set third threshold, the edge 1211 of the piston body 121 is further lifted compared to the working state shown in FIG. 9C, thereby increasing the gap between the edge 1211 of the piston body 121 and the lower edge 134 of the base 130 (not shown in the figure), allowing gas to enter the gas exchange chamber C2 more smoothly. In addition, with the lifting of the piston body 121, the compression core 122 also moves further towards the first direction A under the action of the second spring 1214. As the compression core 122 moves towards the first direction A, the first spike 1221 moves towards the breathable membrane 170 by a distance of at least a first gap H1 and ruptures the breathable membrane 170, causing breathable holes to appear on the surface of the breathable membrane 170, thereby further improving the exhaust efficiency. As the internal pressure of the battery pack rapidly increases, in order to further facilitate exhaust efficiency, the breathable membrane 170 expands towards the second spike 143 in the first direction A by at least a height of the second gap H2, as shown by the dashed line in FIG. 9C. This allows the second spike 143 to further expand the breathable hole on the basis of the first spike 1221 breaking the breathable membrane 170, thereby further improving the exhaust efficiency. Thus when the pressure inside the battery pack rapidly increases, the internal gas can be discharged in a timely manner, ensuring pressure balance between the internal and external environment of the battery pack.

On the premise that it is technically feasible, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A valve for a battery pack, comprising:
a valve bracket having a first opening located at a first end and a second opening located at an opposite, second end;
a breathable membrane that covers the first opening; and
a piston that covers the second opening and includes a hole closed by an openable sealing portion.

2. The valve according to claim 1, wherein the openable sealing portion is at least one of a sealing core, a valve disc, and a notch.

3. The valve according to claim 1, wherein the openable sealing portion is a sealing core that is biased in a first direction by a first elastic member to close the hole.

4. The valve according to claim 3, wherein the valve bracket further comprises a base that supports the first elastic member, the second opening provided in the base.

5. The valve according to claim 4, wherein the base and a body of the valve bracket are connected together in a detachable manner or integrally formed.

6. The valve according to claim 3, wherein the piston has a supporting portion at its bottom, by which the first elastic member is supported.

7. The valve according to claim 3, wherein the valve bracket has a guide groove, and the sealing core is biased by the first elastic member to partially pass through the hole and enter the guide groove.

8. The valve according to claim 1, wherein the piston is biased in a second direction by a second elastic member to cover the second opening.

9. The valve according to claim 8, wherein the openable sealing portion is a sealing core, wherein the sealing core moves under a first pressure difference to open the hole, so as to allow gas from external environment to flow into an interior of a shell of the battery pack.

10. The valve according to claim 1, wherein the openable sealing portion is a notch that deforms under a first pressure difference to open the hole, so as to allow gas from external environment to flow into an interior of a shell of the battery pack.

11. The valve according to claim 1, wherein the openable sealing portion is a valve disc that pivots around a disc shaft under a first pressure difference to open the hole.

12. The valve according to claim 1, wherein the piston moves under a second pressure difference to open the first opening, so as to allow gas inside a shell of the battery pack to flow out.

13. The valve according to claim 1, wherein the openable sealing portion is a sealing core that is biased in a first direction by a first elastic member to close the hole, wherein the sealing core is a sealing plate that covers the hole to close the hole.

14. The valve according to claim 13, wherein the sealing core has a core body and a flange extending outward from the core body in a circumferential direction and biased by the first elastic member to abut against the hole to seal the hole.

15. The valve according to claim 13, wherein the sealing core has a first spike extending towards the breathable membrane and spaced apart from the breathable membrane by a first gap.

16. The valve according to claim 1, wherein the valve further comprises a valve cover having a connecting portion connected to a shell of the battery pack;
the valve cover is attached to an upper end of the valve bracket and covers the breathable membrane with a second gap; and
the valve cover has a second spike extending towards the breathable membrane and having a length smaller than the second gap.

17. The valve according to claim 16, wherein the valve cover has at least one valve cover window located on a side wall and above the breathable membrane in a longitudinal direction when the valve cover is attached to the upper end of the valve bracket.

18. A method for controlling pressure of a battery pack, comprising:
providing at least one gas exchange chamber with a first channel and a second channel, wherein the first channel and the second channel are respectively in fluid communication with external environment and interior of a shell of the battery pack;
wherein the at least one gas exchange chamber is configured to:
close the first channel and the second channel when there is no pressure difference;
open the first channel when there is a first pressure difference to allow gas from the external environment to flow into the interior of the shell of the battery pack; and
open the second channel when there is a second pressure difference to allow gas inside the shell of the battery pack to flow to the external environment.

19. The method according to claim 18, further comprising:
providing a breathable membrane between the at least one gas exchange chamber and the external environment to prevent moisture from entering the at least one gas exchange chamber; and
rupturing the breathable membrane to increase gas passage through the second channel when the second pressure difference is greater than a threshold.

20. A battery pack comprising a valve installed on a shell of the battery pack, the valve comprising:
a valve bracket having a first opening located at a first end and a second opening located at an opposite, second end;
a breathable membrane that covers the first opening; and
a piston that covers the second opening and includes a hole closed by an openable sealing portion.
